(19) United States
(12) Patent Application Publication
(10) Pub. No.: US 2009/0160540 A1
(43) Pub. Date: Jun. 25, 2009

(54) POWER-UP CIRCUIT FOR REDUCING A VARIATION IN TRIGGERING VOLTAGE IN A SEMICONDUCTOR INTEGRATED CIRCUIT

(76) Inventor: Kwang Myoung RHO, Gyeonggi-do (KR)

Correspondence Address: LADAS & PARRY LLP, 224 SOUTH MICHIGAN AVENUE, SUITE 1600, CHICAGO, IL, 60604, US

(21) Appl. No.: 12/206,975

(22) Filed: Sep. 9, 2008

(30) Foreign Application Priority Data
Dec. 20, 2007 (KR) 10-2007-0134033

(51) Int. Cl. G05F 1/10

(52) U.S. Cl. 327/543; 327/538

(57) ABSTRACT

A power-up circuit for reducing a variation in triggering voltage in a semiconductor integrated circuit is described. The power-up circuit includes a pull-up resistor unit that is connected to a power voltage source. A pull-up resistance adjusting unit varies the resistance value of the pull-up resistor unit. The power-up circuit also includes a pull-down resistor unit that is connected between the pull-up resistor unit and a ground. Finally, the power-up circuit includes a detector connected to a common node of the pull-up resistor unit and the pull-down resistor unit.

### CROSS-REFERENCE TO RELATED APPLICATIONS

The present application claims priority to Korean patent application number 10-2007-0134033 filed on Dec. 20, 2007, which is incorporated herein by reference in its entirety.

### BACKGROUND OF THE INVENTION

The present invention relates to a semiconductor integrated circuit, and more particularly to a power-up circuit driving an initialization of circuits mounted on a chip.

A power-up circuit as a semiconductor integrated circuit used in DRAM and ASIC products, etc. detects a potential level of an external power voltage to generate a specific initialization signal, i.e. a power-up signal, to initialize various circuits mounted on a chip.

The power-up signal has the same level as a ground voltage before the external power voltage level is stabilized and has the same level as the external power voltage when the external power voltage level is increased beyond a specific level.

In DRAM and ASIC products, the power-up signal having the above-described property is supplied to various circuits to control an initial voltage of circuit nodes requiring an initialization, i.e. nodes that should have a required designed polarity when a process for stabilizing the power voltage to a specific level is finished.

FIG. 1 shows a general power-up circuit.

Referring to FIG. 1, an inverter type detector in which a PMOS transistor P1 and a NMOS transistor N1 are serially connected detects the external power voltage VDD level, and an output node DET of the detector has different polarities according to the VDD level.

Here, the external power voltage VDD level is detected by a divider having resistors R1 and R2 serially formed between the power voltage VDD and the ground voltage VSS.

A ground voltage VSS is applied to a gate of the PMOS transistor P1, but a voltage level obtained by dividing the external voltage VDD by the resistors R1 and R2 is applied to a gate of the NMOS transistor N1.

An inverter INV1 connected to the output node DET of the detector delivers a signal PWRUP by buffering the output of the detector to other circuits in the chip.

Operational properties of the power-up circuit in FIG. 1 are as shown in a waveform diagram of FIG. 2. In FIG. 2, (A) illustrates a waveform property of the divided VDD voltage—LEVEL, (B) illustrates a waveform property of the detector output—DET, and (C) illustrates a waveform property of the final output—PWRUP.

In more detail, waveform (A) of FIG. 2 illustrates the external voltage VDD level and the resulting level obtained by dividing the external voltage VDD. In the detector of FIG. 1, a VGS value of the PMOS transistor P1 is VDD, but a VGS value of the NMOS transistor N1 becomes (R2/(R1+R2))*VDD. Therefore, where the external voltage VDD gradually increases from the ground level, the potential of the output node DET of the detector increases following the external voltage VDD through the PMOS transistor P1.

Referring to waveform (B) of FIG. 2, the output DET of the detector rises following the power voltage VDD during an initial period. In the initial period, the NMOS transistor within the inverter INV1 (not shown) is turned on earlier and thus the output PWRUP of the inverter INV1 maintains the ground level while the output DET follows the power voltage VDD. This can be further illustrated by referring to an initialization period in waveform (C) of FIG. 2. The initial period described above is referred to as an initialization period and various circuits in the chip initialize specific nodes using the PWRUP signal during this period.

Meanwhile, after the initialization is performed, the power-up signal polarity must be changed and outputted for performing a normal operation. Accordingly, properly adjusting the channel sizes of the PMOS transistor P1 and the NMOS transistor N1 of the detector is required. In other words, the transistors must be designed so that a current driving ability of the NMOS transistor N1 becomes larger than that of the PMOS transistor P1 when the external power voltage VDD becomes larger than a triggering voltage V1. According to such a design, the potential of the output node DET of the detector is lowered to the ground level when the external power voltage VDD becomes larger than the triggering voltage V1, and consequently, the power-up signal PWRUP level becomes identical to the power voltage VDD level (a normal operation period in (B) and (C) of FIG. 2).

FIG. 3 illustrates waveform properties showing the operation of the detector within the power-up circuit in view of the current driving ability of the PMOS transistor P1 and the NMOS transistor N1 according to the power voltage VDD.

In FIG. 3, (A) illustrates a waveform of a divided power voltage VDD level, (B) illustrates current waveforms of the PMOS transistor P1 and the NMOS transistor N1 within the detector, and (C) illustrates current waveforms of the PMOS transistor P1 and the NMOS transistor N1 within the detector at a NMOS transistor fast condition.

Referring to (B) of FIG. 3, the PMOS transistor P1 is first turned on and the current I(P1) increases if the power voltage VDD becomes larger than the threshold voltage VTP. At this time, the NMOS transistor N1 is in an off state. When the power voltage VDD further increases and becomes larger than ((R1+R2)/R2)*VTN, the NMOS transistor N1 is also turned on and current I(N1) starts to increase. However, at this point, there is no change in the detection level since the current I(P1) is larger than the current I(N1).

However, where the size of the NMOS transistor N1 is designed larger than the size of the PMOS transistor P1, the increase in the current I(P1) according to the power voltage VDD is larger than that of the current I(N1). Therefore, the current I(P1) and the current I(N1) become identical to each other when the power voltage VDD reaches a specific triggering voltage V1 and the polarity of the detector is changed.

As illustrated in FIG. 3, the triggering voltage V1 is the value of the external power voltage VDD corresponding to when the current I(P1) and the current I(N1) become identical to each other. This value varies according to the current properties of the NMOS N1 and PMOS P1. In other words, a large variation may occur according to a process variation or an operation temperature of a chip. This is illustrated in (C) of FIG. 3.

If the threshold voltage VTN of the NMOS transistor N1 decreases such that it's identical to the property of the PMOS transistor P1, a curve of the current I(N1) moves towards the left side and the triggering voltage V1 becomes smaller.

FIG. 4 illustrates a variation in the triggering voltage V1 according to a skew in process/temperature and a resultant restriction in the initialization/normal operation periods. In FIG. 4, (A) illustrates a waveform of the detector output—DET and (B) illustrates a waveform of the final output—PWRUP.

As shown in FIG. 4, the variation in the triggering voltage V1 of the power-up circuit according to a related art is generated according to variation in electrical properties of the PMOS transistor P1 and the NMOS transistor N1 of the detector. As a result, the initialization period or the normal operation period is encroached, or in a severe case, the power-up function is hardly performed at all. Therefore, an error in the chip operation may occur.

### SUMMARY OF THE INVENTION

A power-up circuit in a semiconductor integrated circuit that can reduce variation in a triggering voltage is described according to the present invention.

Also, there is provided a power-up circuit in a semiconductor integrated circuit that can minimize variation in a triggering voltage according to variation in process and temperature.

Further, there is provided a power-up circuit in a semiconductor integrated circuit that has a simple circuit configuration while minimizing variation in a triggering voltage according to variation in process and temperature.

Furthermore, there is provided a power-up circuit in a semiconductor integrated circuit in that variation in target areas of an initialization period and a normal operation period is minimized even when variation in process and temperature is generated.

Furthermore, there is provided a power-up circuit in a semiconductor integrated circuit that can minimize variation in a triggering voltage even when variation in process and temperature is generated while simplifying maximally a configuration of a detector.

According to a first embodiment of the present invention, there is provided a power-up circuit in a semiconductor integrated circuit, which includes: a pull-up resistor unit connected to a power voltage; a pull-up resistance adjusting unit varying the resistance value of the pull-up resistor unit; a pull-down resistor unit connected between the pull-up resistor unit and a ground; and a detector connected to a common node of the pull-up resistor unit and the pull-down resistor unit.

Preferably, the pull-up resistor unit includes first and second pull-up resistors serially connected to each other, and the pull-up resistance adjusting unit is connected between the first and second pull-up resistors. Also, the pull-up resistance adjusting unit includes a resistive transistor normally turned on to vary the resistance value of the pull-up resistor unit, and the pull-up resistance adjusting unit includes a PMOS transistor with a gate thereof being connected to the ground voltage.

Preferably, the pull-down resistor unit includes first and second pull-down resistors serially connected to each other.

According to a second embodiment of the present invention, there is provided a power-up circuit in a semiconductor integrated circuit, which includes: a pull-up resistor unit connected to a power voltage; a pull-down resistor unit connected between the pull-up resistor unit and a ground; a pull-down resistance adjusting unit varying the resistance value of the pull-down resistor unit; and a detector connected to a common node of the pull-up resistor unit and the pull-down resistor unit.

Preferably, the pull-up resistor unit includes first and second pull-up resistors serially connected to each other, and the pull-down resistor unit includes first and second pull-down resistors serially connected to each other. Also, the pull-down resistance adjusting unit is connected between the first and second pull-down resistors. Preferably, the pull-down resistance adjusting unit includes a resistive transistor normally turned on to vary the resistance value of the pull-down resistor unit, and the pull-down resistance adjusting unit includes a NMOS transistor with a gate thereof being connected to the power voltage.

According to a third embodiment of the present invention, there is provided a power-up circuit in a semiconductor integrated circuit, which includes: a pull-up resistor unit connected to a power voltage; a pull-up resistance adjusting unit varying the resistance value of the pull-up resistor unit; a pull-down resistor unit connected between the pull-up resistor unit and a ground; a pull-down resistance adjusting unit varying the resistance value of the pull-down resistor unit; and a detector connected to a common node of the pull-up resistor unit and the pull-down resistor unit.

Preferably, the pull-up resistor unit includes first and second pull-up resistors serially connected to each other, and the pull-up resistance adjusting unit is connected between the first and second pull-up resistors. Also, the pull-up resistance adjusting unit includes a resistive transistor normally turned on to vary the resistance value of the pull-up resistor unit, and more preferably, the pull-up resistance adjusting unit includes a PMOS transistor with a gate thereof being connected to the ground voltage.

Preferably, the pull-down resistor unit includes first and second pull-down resistors serially connected to each other. The pull-down resistance adjusting unit is connected between the first and second pull-down resistors. Also, the pull-down resistance adjusting unit includes a resistive transistor normally turned on to vary the resistance value of the pull-down resistor unit, and more preferably the pull-down resistance adjusting unit includes a NMOS transistor with a gate thereof being connected to the power voltage.

According to a fourth embodiment of the present invention, there is provided a power-up circuit in a semiconductor integrated circuit, which includes: a divider dividing a power voltage through a plurality of resistors formed between a power voltage applying terminal and a ground; a resistance adjusting unit varying resistance values of the plurality of resistors of the divider; and a detector connected to the output terminal of the divider.

Preferably, the divider includes a pull-up resistor unit pulling up the output terminal and a pull-down resistor unit pulling down the output terminal.

Preferably, the resistance adjusting unit is connected to the pull-up resistor unit or the pull-down resistor unit.

Preferably, the resistance adjusting unit includes a resistive transistor normally turned on to vary the resistance value of the pull-up resistor unit.

Preferably, the pull-up resistor unit includes first and second pull-up resistors serially connected to each other, and the pull-down resistor unit includes first and second pull-down resistors serially connected to each other.

The present invention relates to a power-up circuit having small variation in a triggering voltage according to a process/temperature variation, and can aid in performing a stable initialization of a chip and thus can be valuably utilized in DRAM and ASIC products with high speed and high integration

### BRIEF DESCRIPTION OF THE DRAWINGS

FIG. 1 is a circuit diagram showing a conventional power-up circuit.

FIG. 2 is a waveform diagram illustrating an operation of FIG. 1.

FIG. 3 is a waveform diagram illustrating an output curve of the DET of a detector in FIG. 1.

FIG. 4 is a waveform diagram illustrating the process/temperature skewing of a triggering level of FIG. 1.

FIG. 5 is a circuit diagram showing a power-up circuit according to a first embodiment of the present invention.

FIG. 6 is a waveform diagram illustrating a reduction in the process/temperature skewing according to the configuration in FIG. 5 as compared with the conventional configuration.

FIG. 7 is a circuit diagram showing a power-up circuit according to a second embodiment of the present invention.

FIG. 8 is a circuit diagram showing a power-up circuit according to a third embodiment of the present invention.

### DESCRIPTION OF SPECIFIC EMBODIMENTS

Hereinafter, preferred embodiments of the present invention will be described in detail with reference to the accompanying drawings.

The present invention is characterized in that an output level of a resistor divider is varied according to a variation in process/temperature to reduce variation in a triggering voltage V1 of a detector due to the process/temperature variation. In other words, an input signal level value of the detector is varied according to the variation in the logic threshold voltage to cancel variation in a logic threshold voltage of the existing detector due to the variation in process/temperature.

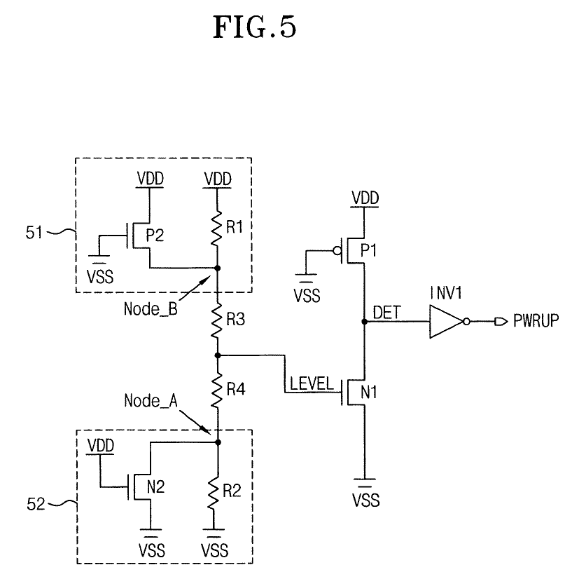

FIG. 5 shows a first embodiment of the present invention and is characterized in that a specific portion of a resistor divider is shunted with a NMOS or PMOS device to properly change an output voltage LEVEL of the resistor divider which divides an external voltage, i.e. an input voltage applied to the detector, according to a process/temperature variation. In other words, according to the present invention, reference numerals 51 and 52 in FIG. 5 denote portions that change the output voltage LEVEL, i.e. the input signal of the detector.

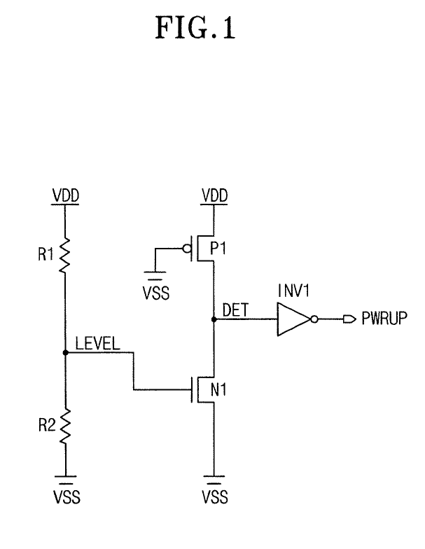

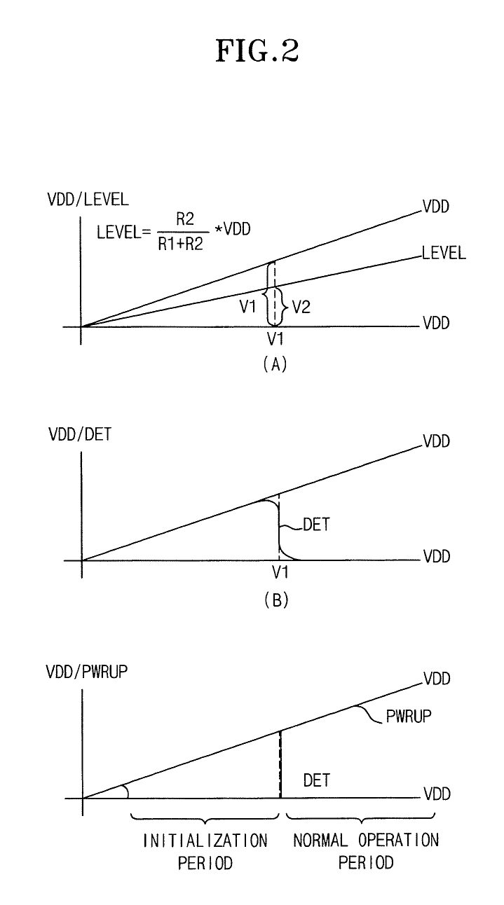

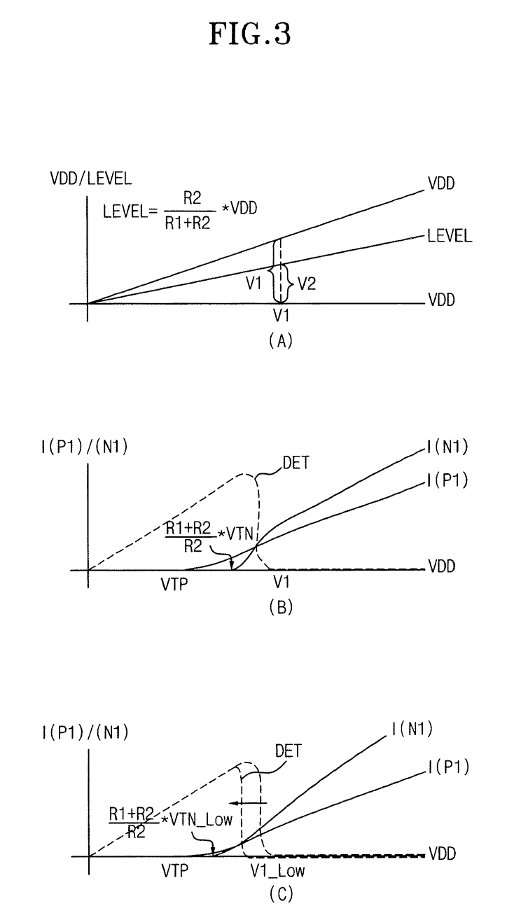

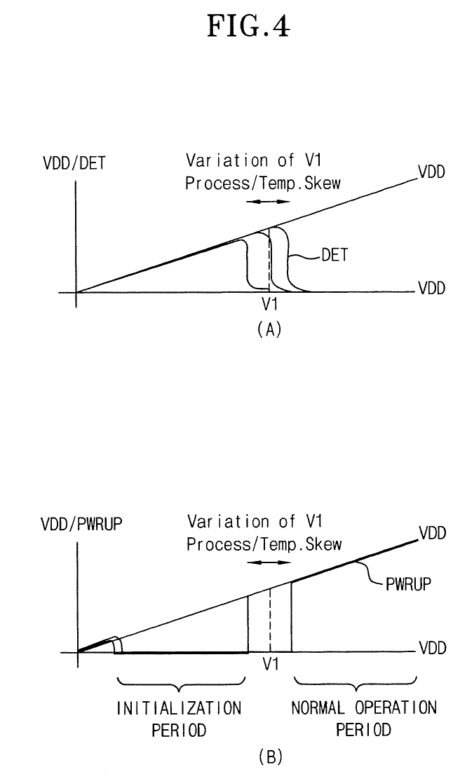

Referring to the aforementioned FIG. 1, the resistor divider includes the resistor R1 and the resistor R2 in the conventional power-up circuit however, the resistor divider as shown in FIG. 5 includes resistors R1/R3 and resistors R2/R4 that are serially connected. The resistor R2 is connected in parallel with a NMOS transistor N2 and the resistor R1 is connected in parallel with a PMOS transistor P2. Therefore, an effective resistance between a node Node_A and the ground VSS is influenced by a device property of the NMOS transistor N2, and an effective resistance between the power voltage VDD and a node Node_B is influenced by a device property of the PMOS transistor P2.

If the current driving ability of the NMOS transistor N2 increases and the current driving ability of the PMOS transistor P2 decreases according to a process/temperature variation, the effective resistance between the node Node_A and ground VSS is reduced while the effective resistance between the power voltage VDD and node Node_B is increased. As a result, the output voltage of the resistor divider is reduced, i.e. the output voltage LEVEL.

On the contrary, if the current driving ability of the NMOS transistor N2 decreases and the current driving ability of the PMOS transistor P2 increases according to the process/temperature variation, the effective resistance between the node Node_A and ground VSS is increased while the effective resistance between the power voltage VDD and node Node_B is reduced. As a result, the output voltage of the resistor divider is increased, i.e. the output voltage LEVEL.

The above-described effect is realized according to the configuration of the present invention. As the result, the variation in the logic threshold voltage of the detector, which is a successive circuit of the resistor, according to the process/temperature variation is canceled. Thus, the output voltage DET of the detector becomes insensitive to the process/temperature variation.

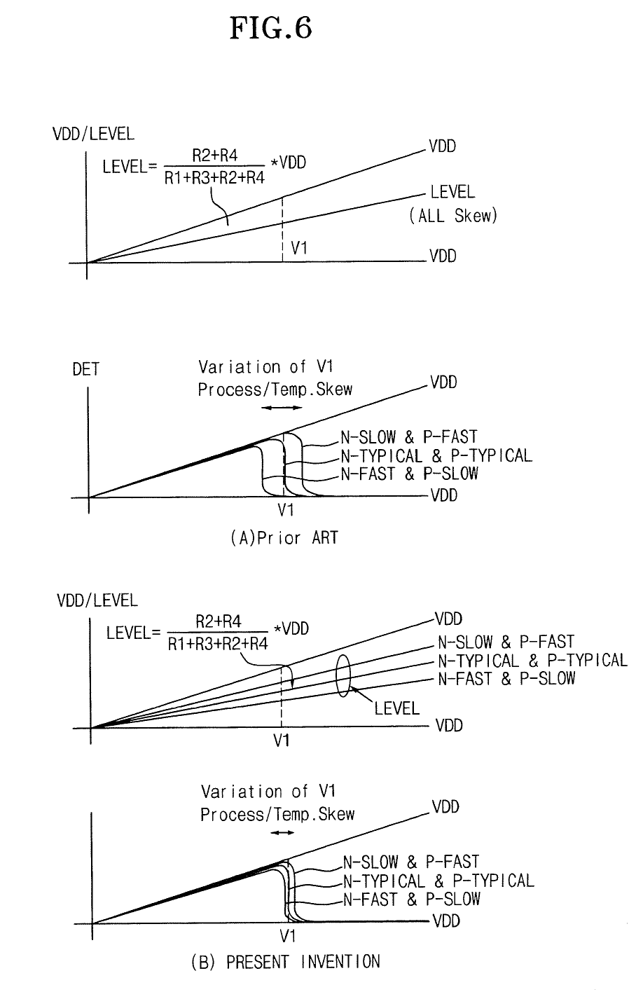

If the current driving ability of the NMOS transistor N2 increases and the current driving ability of the PMOS transistor P2 decreases according to the process/temperature variation (N-fast & P-slow condition), the logic threshold voltage of the detector including the NMOS transistor N1 and the PMOS transistor P1 decreases. In this case, the output voltage LEVEL of the divider under the constant power voltage VDD also decreases. Thus the value V1 of the external voltage VDD triggered by the detector, i.e. the triggering voltage level, is not largely varied (refer to FIG. 6).

On the contrary, if the current driving ability of the NMOS transistor N2 decreases and the current driving ability of the PMOS transistor P2 increases according to the process/temperature variation (N-slow & P-fast condition), the logic threshold voltage of the detector including the NMOS transistor N1 and the PMOS transistor P1 increases. In this case, the output voltage LEVEL of the divider under the constant power voltage VDD also increases. Thus the value V1 of the external voltage VDD triggered by the detector, i.e. the triggering voltage level, is not largely varied (refer to FIG. 6).

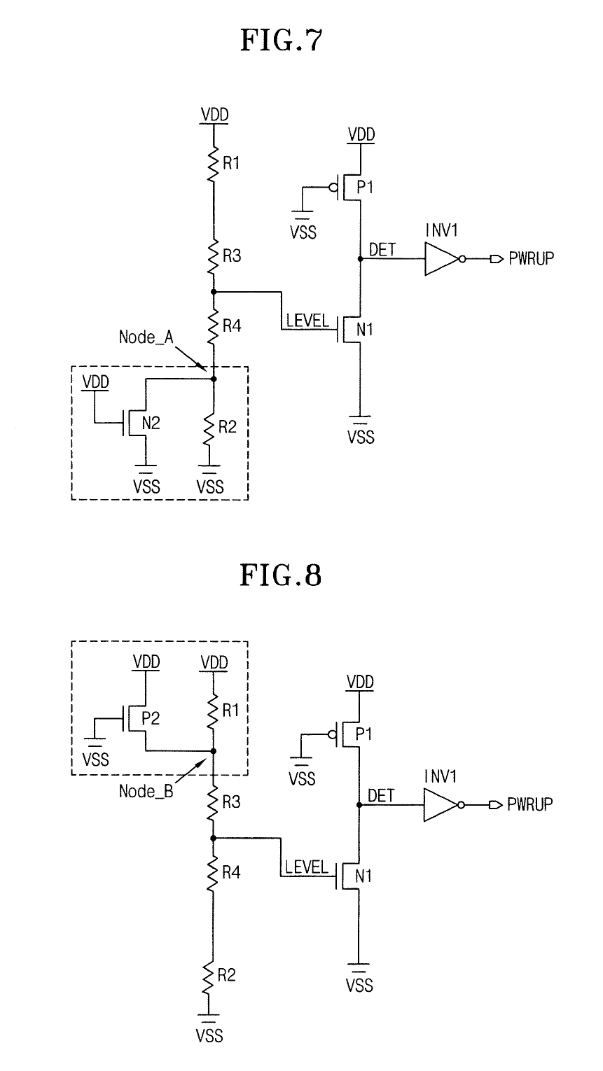

FIG. 7 shows a second embodiment of the present invention in which only the NMOS transistor N2 is connected in parallel to a resistor R2 in the resistor divider for dividing the power voltage VDD as shown in FIG. 5. In this case, it is also possible to obtain an effect similar to where both the NMOS transistor and PMOS transistor are connected in parallel, as shown in FIG. 5.

FIG. 8 shows a third embodiment of the present invention in which only the PMOS transistor P2 is connected in parallel to a resistor R1 in the resistor divider for dividing the power voltage VDD as shown in FIG. 5. In this case, it is also possible to obtain an effect similar to where both the NMOS transistor and PMOS transistor are connected in parallel, as shown in FIG. 5.

Those skilled in the art will appreciate that the specific embodiments disclosed in the foregoing description may be readily utilized as a basis for modifying or designing other embodiments for carrying out the same purposes of the present invention. Those skilled in the art will also appreciate that such equivalent embodiments do not depart from the spirit and scope of the invention as set forth in the appended claims.

What is claimed is:

1. A power-up circuit in a semiconductor integrated circuit, comprising:
a pull-up resistor unit connected to a power voltage;
a pull-up resistance adjusting unit varying a resistance value of the pull-up resistor unit;
a pull-down resistor unit connected between the pull-up resistor unit and a ground voltage; and
a detector connected to a common node of the pull-up resistor unit and the pull-down resistor unit.

2. The power-up circuit in a semiconductor integrated circuit as set forth in claim 1, wherein the pull-up resistor unit includes serially connected first and second pull-up resistors.

3. The power-up circuit in a semiconductor integrated circuit as set forth in claim 2, wherein the pull-up resistance adjusting unit is connected between the first and second pull-up resistors.

4. The power-up circuit in a semiconductor integrated circuit as set forth in claim 1, wherein the pull-up resistance adjusting unit includes a resistive transistor normally turned on to vary the resistance value of the pull-up resistor unit.

5. The power-up circuit in a semiconductor integrated circuit as set forth in claim 4, wherein the resistive transistor of the pull-up resistance adjusting unit is a PMOS transistor with a gate thereof being connected to the ground voltage.

6. The power-up circuit in a semiconductor integrated circuit as set forth in claim 1, wherein the pull-down resistor unit includes serially connected first and second pull-down resistors.

7. A power-up circuit in a semiconductor integrated circuit, comprising:
a pull-up resistor unit connected to a power voltage;
a pull-down resistor unit connected between the pull-up resistor unit and a ground voltage;
a pull-down resistance adjusting unit varying a resistance value of the pull-down resistor unit; and
a detector connected to a common node of the pull-up resistor unit and the pull-down resistor unit.

8. The power-up circuit in a semiconductor integrated circuit as set forth in claim 7, wherein the pull-up resistor unit includes serially connected first and second pull-up resistors.

9. The power-up circuit in a semiconductor integrated circuit as set forth in claim 7, wherein the pull-down resistor unit includes serially connected first and second pull-down resistors.

10. The power-up circuit in a semiconductor integrated circuit as set forth in claim 9, wherein the pull-down resistance adjusting unit is connected between the first and second pull-down resistors.

11. The power-up circuit in a semiconductor integrated circuit as set forth in claim 7, wherein the pull-down resistance adjusting unit includes a resistive transistor normally turned on to vary the resistance value of the pull-down resistor unit.

12. The power-up circuit in a semiconductor integrated circuit as set forth in claim 11, wherein the resistive transistor of the pull-down resistance adjusting unit is a NMOS transistor with a gate thereof being connected to the power voltage.

13. A power-up circuit in a semiconductor integrated circuit, comprising:
a pull-up resistor unit connected to a power voltage;
a pull-up resistance adjusting unit varying a resistance value of the pull-up resistor unit;
a pull-down resistor unit connected between the pull-up resistor unit and a ground voltage;
a pull-down resistance adjusting unit varying a resistance value of the pull-down resistor unit; and
a detector connected to a common node of the pull-up resistor unit and the pull-down resistor unit.

14. The power-up circuit in a semiconductor integrated circuit as set forth in claim 13, wherein the pull-up resistor unit includes serially connected first and second pull-up resistors.

15. The power-up circuit in a semiconductor integrated circuit as set forth in claim 14, wherein the pull-up resistance adjusting unit is connected between the first and second pull-up resistors.

16. The power-up circuit in a semiconductor integrated circuit as set forth in claim 13, wherein the pull-up resistance adjusting unit includes a resistive transistor normally turned on to vary the resistance value of the pull-up resistor unit.

17. The power-up circuit in a semiconductor integrated circuit as set forth in claim 16, wherein the resistive transistor of the pull-up resistance adjusting unit is a PMOS transistor with a gate thereof being connected to the ground voltage.

18. The power-up circuit in a semiconductor integrated circuit as set forth in claim 13, wherein the pull-down resistor unit includes serially connected first and second pull-down resistors.

19. The power-up circuit in a semiconductor integrated circuit as set forth in claim 18, wherein the pull-down resistance adjusting unit is connected between the first and second pull-down resistors.

20. The power-up circuit in a semiconductor integrated circuit as set forth in claim 13, wherein the pull-down resistance adjusting unit includes a resistive transistor normally turned on to vary the resistance value of the pull-down resistor unit.

21. The power-up circuit in a semiconductor integrated circuit as set forth in claim 20, wherein the resistive transistor of the pull-down resistance adjusting unit is a NMOS transistor with a gate thereof being connected to the power voltage.

22. A power-up circuit in a semiconductor integrated circuit, comprising:
a divider dividing a power voltage through a plurality of resistors formed between a power voltage applying terminal and a ground voltage;
a resistance adjusting unit varying resistance values of the plurality of resistors of the divider; and
a detector connected to an output terminal of the divider.

23. The power-up circuit in a semiconductor integrated circuit as set forth in claim 22, wherein the divider includes a pull-up resistor unit pulling up an output terminal level of the divider and a pull-down resistor unit pulling down the output terminal level of the divider.

24. The power-up circuit in a semiconductor integrated circuit as set forth in claim 23, wherein the resistance adjusting unit is connected to the pull-up resistor unit.

25. The power-up circuit in a semiconductor integrated circuit as set forth in claim 23, wherein the resistance adjusting unit is connected to the pull-down resistor unit.

26. The power-up circuit in a semiconductor integrated circuit as set forth in claim 24, wherein the resistance adjusting unit includes a resistive transistor normally turned on to vary the resistance value of the pull-up resistor unit.

27. The power-up circuit in a semiconductor integrated circuit as set forth in claim 25, wherein the resistance adjusting unit includes a resistive transistor normally turned on to vary the resistance value of the pull-down resistor unit.

28. The power-up circuit in a semiconductor integrated circuit as set forth in claim 23, wherein the pull-up resistor unit includes serially connected first and second pull-up resistors.

29. The power-up circuit in a semiconductor integrated circuit as set forth in claim 23, wherein the pull-down resistor unit includes serially connected first and second pull-down resistors.
